(19) United States
(12) Patent Application Publication
(10) Pub. No.: US 2026/0328168 A1
(43) Pub. Date: Oct. 22, 2026

(54) METHOD FOR OPERATING A GAS INJECTOR

(71) Applicant: Robert Bosch GmbH, Stuttgart (DE)

(72) Inventors: Christian Bayer, Vaihingen (DE); Frank Ilgner, Stuttgart (DE); Oezguer Tuerker, Gerlingen (DE); Torsten Burock, Vaihingen An Der Enz (DE); Bernd Wichert, Kernen (DE); Lukas Reiniger, Stuttgart (DE)

(21) Appl. No.: 19/112,155

(22) PCT Filed: Jun. 28, 2023
(86) PCT No.: PCT/EP2023/067643

§ 371 Date: May 6, 2025

(30) Foreign Application Priority Data
Sep. 21, 2022 (DE) 10 2022 209 912.5

(51) Int. Cl. F02M 21/02; F02D 19/02; F02M 51/06

(52) U.S. Cl. CPC F02M 21/0254; F02D 19/021; F02M 51/0614

(57) ABSTRACT

A method for operating a gas injector of an internal combustion engine in order to avoid closing bounces during a closing process of an armature of a magnetic actuator. The method includes: ending energization of the magnetic actuator at a switching time t0 to initiate the closing process of the gas injector; and determining a switching time t3 after a period of time Z has elapsed after the switching time t0, at which switching time a voltage U of the magnetic actuator is set to zero.

### FIELD

The present invention relates to a method for operating a gas injector of an internal combustion engine in order to avoid closing bounces during a closing movement of an armature of a magnetic actuator.

### BACKGROUND INFORMATION

Gas injectors are described in the related art in different designs. Due to the gaseous medium to be injected, for example hydrogen or methane or the like, improved control of the opening and closing process of the gas injector is necessary to maintain exact injection quantities. During the closing process, due to the lack of hydraulic damping, so-called closing bounces easily occur compared to injectors for liquid fuels. In the case of such closing bounces, the gas injector opens again so that an additional amount of gas is injected, which can significantly increase the defined amount of gas to be injected. As a result, increased wear on the sealing seat and loud noises, in particular when a plurality of closing bounces occur in succession, are also generated.

### SUMMARY

A method according to an example embodiment of the present invention for operating a gas injector of an internal combustion engine in order to avoid closing bounces during a closing process of an armature of a magnetic actuator may have an advantage that closing bounces can be reliably avoided. As a result, reduced deficits of the gas to be injected and a significantly improved noise behavior of the gas injector during operation arise. The method according to the present invention is very robust and repeatable with a high degree of accuracy. This is achieved according to an example embodiment of the present invention in that, in order to close the opened gas injector, energization of the magnetic actuator of the gas injector is ended at a switching time t0, so that a current I becomes zero at a second switching time t1. After a period of time Z has elapsed after the first switching time t0, a voltage U of zero is applied to a coil of the magnetic actuator of the gas injector. This measure prevents the voltage from increasing according to an e-function after the switching time t0, at which the current I becomes equal to zero, as in the related art, and from reaching a level of U equal to zero only after eddy currents in the magnetic actuator have subsided with a significant delay. In the method according to the present invention, this conventional extinguishing phase is prematurely ended in the form of the e-function and the voltage U of zero is applied to the coil of the magnetic actuator. After the voltage switches to zero, the magnetic force decay occurs significantly slower compared to the related art. The slower magnetic force decay results in the fact that a resulting force does not increase as rapidly over time. As a result, a slowed closing of the gas injector arises, which also leads to a reduction in an impact speed of the armature against an armature stop. This prevents the gas injector from reopening due to closing bounces and significantly improves a noise behavior of the gas injector.

Preferred developments of the present invention are disclosed herein.

According to an example embodiment of the present invention, preferably, a switching time t3 of the voltage to zero after the ending of the energization of the magnetic actuator for the closing process of the gas injector is not always carried out at a constant set value after the end of the energization of the magnetic actuator, but the switching time t3 of U equal to zero is varied according to a closing behavior of the gas injector. As a result, the best possible braking effect during the resetting of the armature can be achieved.

The switching time t3 of the voltage to zero should be determined very precisely. If the switching to the voltage U to zero is carried out too late, the braking effect for the armature is low, so that the armature still hits the armature stop at high speed, which could then lead to closing bounces. If the switching of the voltage U to zero is carried out too early, the braking effect of the armature is too strong, which results in a significant deterioration in the metering accuracy of the gaseous fuel to be injected.

According to an example embodiment of the present invention, in order to determine the correct switching time of the switching of the voltage to zero after the start of the closing process as accurately as possible, a position of the armature of the magnetic actuator is preferably detected. As a result, the switching time t3 to zero can be determined very precisely.

Further preferably, according to an example embodiment of the present invention, in order to avoid closing bounces, a starting time L is determined at a switching time t2 of the armature and the switching time t3 of the voltage is set to zero only after the starting time L.

Further preferably, according to an example embodiment of the present invention, the voltage U equal to zero is applied only if the current I of the magnetic actuator has reached the value zero after the start of the closing process.

Alternatively, the voltage is set to zero after the gas injector has started the closing process, even before the current I of the magnetic actuator has reached the value zero. As a result, an earlier deceleration of the armature is made possible.

According to a further preferred design of the present invention, the period of time Z between the start of closing of the gas injector and the switching time t3 of the voltage U to zero is determined according to a starting time L of the armature and/or a closing speed of the armature and/or an actual closing time of the gas injector. The period of time Z can be determined by means of a learning system, which is preferably arranged in a control unit of the gas internal combustion engine. As a result, an individual adjustment of the period of time Z via the gas internal combustion engine during operation can be carried out if, for example, the closing speed of the armature changes due to external influences, e.g. due to varying friction.

Preferably, according to an example embodiment of the present invention, the starting time L of the armature during the closing movement is determined on the basis of current values and voltage values of the magnetic actuator. Preferably, a measurement of the current I and the voltage of the magnetic actuator is performed in a pressureless state of the gas injector and a first Psi(t) profile is calculated in the pressureless state. The Psi(t) profile is an integration of an induced voltage over the control profile of the magnetic actuator. In a further step, the measurement of the current I and the voltage of the magnetic actuator is then repeated in a pressurized state of the gas injector. From this, a second Psit(t) profile is calculated for the pressurized state and subsequently a comparison is performed between the first and the second Psi(t) profile and the starting time of the armature is determined. The starting time L is the point at which the two Psi(t) profiles start to diverge from one another.

Preferably, according to an example embodiment of the present invention, the switching time of the valve closing, i.e. if a closing element of the gas injector seals again at a sealing seat, is determined by means of a local maximum of the current I. This is preferably determined in such a way that a current profile of the magnetic actuator is monitored. When the armature is at rest, the current I initially increases to an output level after the switching of the voltage to zero. The current I of the coil then slowly decays with a time constant. However, when the armature is moving, the inductance is not constant. When the armature is moving during the closing process, the current I drops significantly more slowly than when the armature is at rest. During a rapid closing movement, the current I can even increase. At the moment of valve closing (armature speed equal to zero), the armature speed and thus also a first derivative of the current I changes very rapidly. Therefore, the current profile over time shows a strong downward curvature typical for this moment, which can be detected as the closing time of the armature.

According to an example embodiment of the present invention, the switching time of the voltage U to zero is preferably performed by a control in the same cycle, so that a simultaneous adjustment of the switching time t3 is carried out with each injection or alternatively a switching time can be determined, for example averaged, from a plurality of measuring cycles.

Furthermore, the present invention relates to a control unit that is configured to carry out steps of the method according to the present invention. Particularly preferably, the control unit carries out a control loop in order to improve an injection accuracy of the gas injector by optimizing the closing process.

Furthermore, a computer program having a program code is proposed which carries out steps of the method according to the present invention when the computer program runs on a computer or a corresponding computing unit, for example on a control unit according to the present invention.

Furthermore, a computer program product having a computer program according to the present invention is provided which is stored on a machine-readable data carrier or storage medium.

Furthermore, the present invention relates to a gas injector of a gas internal combustion engine that is configured to carry out the method according to the present invention.

### BRIEF DESCRIPTION OF EXAMPLE EMBODIMENTS

Exemplary embodiments of the present invention are described in detail below with reference to the figures.

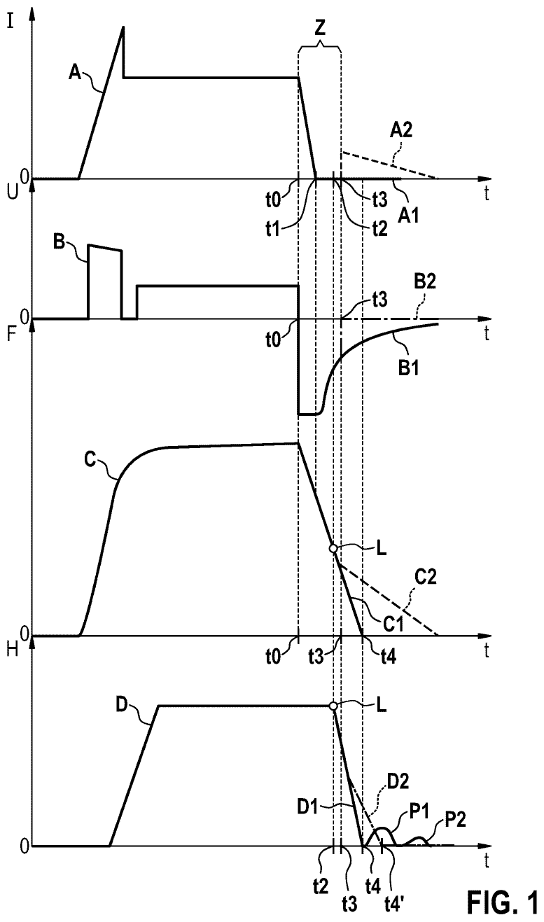

FIG. 1 is a schematic representation that shows four diagrams for a current I, a voltage U, a magnetic force F and a valve lift H of a gas injector over time, one above the other, in order to explain the method according to the present invention according to a first exemplary embodiment.

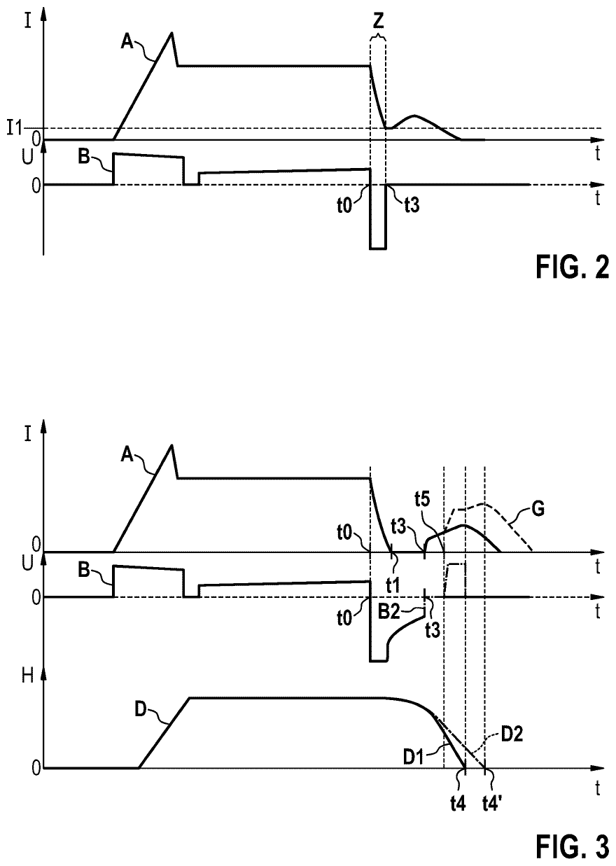

FIG. 2 is a schematic representation that shows two diagrams of the current I and the voltage U over time t in order to explain the method according to the present invention according to a second exemplary embodiment of the present invention.

FIG. 3 is a schematic representation that shows three diagrams of the current I, the voltage U and the valve lift H over time t in order to explain the method according to the present invention according to a third exemplary embodiment.

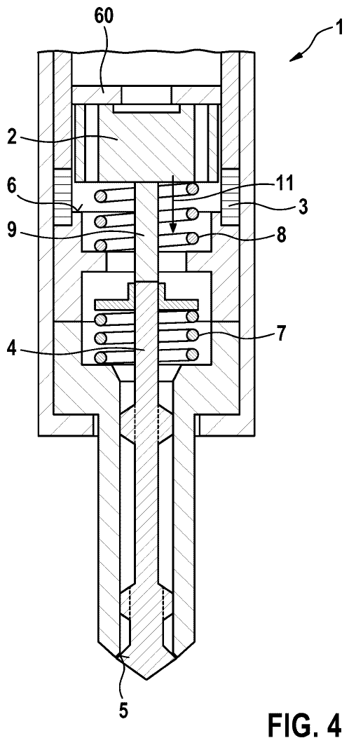

FIG. 4 is a longitudinal section through a gas injector that is configured to perform the method according to the present invention.

### DETAILED DESCRIPTION OF EXAMPLE EMBODIMENTS

The present invention is described in detail below with reference to FIGS. 1 and 4 according to a first exemplary embodiment.

FIG. 4 shows by way of example a gas injector 1 with a magnetic actuator. The magnetic actuator comprises a magnetic coil 3 for acting on an axially movable armature 2. The armature 2 can be brought into contact with a closing element 4, in particular a valve needle, in order to release an injection cross-section at a sealing seat 5. The reference sign 8 denotes a reset element of the gas injector. The closing element 4 is held in the closed position shown in FIG. 4 by means of a valve spring 7.

If the magnetic coil 3 is energized, a magnetic field is formed, the magnetic force of which moves the armature 2 in the direction of the closing element 4 (arrow 11). An armature bolt 9 connected to the armature 2 comes into contact with the closing element 4, so that the closing element 4 is opened against the spring force of the valve spring 7 on the sealing seat 5. The armature 2 is moved up to a stroke stop 6 for the armature, which represents the fully opened state of the gas injector.

In order to close the gas injector 1, the energization of the magnetic coil 3 is ended, so that the reset element 8 returns the armature 2 to the initial position shown in FIG. 4. At the same time, the valve spring 7 also returns the closing element 4 to the closed position shown in FIG. 4.

FIG. 1 schematically shows a method according to a first exemplary embodiment of the present invention. In order to clarify the present invention, four diagrams are shown one above the other, in order to improve the sequences and understanding of the present invention.

The top diagram in FIG. 1 shows the current I fed to the magnetic actuator over time t during an injection cycle as curve A. Starting from point zero, which represents the closed state of the gas injector without energization (I=0), the current I increases rapidly after an opening command for the magnetic actuator. Subsequently, the current I is kept substantially constant over time t, which shows the open state of the gas injector, in which an injection of gaseous fuel follows. At a switching time t0, the energization of the magnetic actuator is ended, in order to start the closing process of the gas injector. At the switching time t1, the current I is then zero again. Without performing the method according to the present invention, the current I remains at the level zero, which is marked with A1 in FIG. 1.

The second diagram in FIG. 1 shows the voltage U over time t (curve B). At the switching time t0, which represents the start of the closing time, the voltage becomes negative. At the switching time t1, at which the current I becomes equal to zero, the voltage U starts to approach the value zero again in an e-function, which is denoted by B1 in FIG. 1 for the profile in the related art.

The third diagram of FIG. 1 shows the magnetic force F over time t (curve C). During the closing process, the magnetic force decreases substantially linearly starting from the switching time t0, wherein in the related art, according to curve C1, it is zero at a switching time t4 at which the armature hits the armature stop.

The bottom diagram in FIG. 1 shows the valve lift H over time t (curve D). Here, the bottom diagram shows a starting time L at the switching time t2. For reasons of inertia, the closing element of the gas injector does not start the return movement to the closed state immediately at the switching time t0, but only at the switching time t2. If the closing element reaches the closed state at the switching time t4 (curve D1 in FIG. 1), two closing bounces P1 and P2 arise due to the high closing speed. These are avoided by the concept according to the present invention, which is described below.

According to the present invention, after a period of time Z (see FIG. 1, second diagram), a switching time at which the voltage U is set to zero is defined. In FIG. 1, this is the switching time t3. As can be seen from the diagram of voltage U over time t, as a result a voltage curve B2, which is shown in a dashed line, arises. The voltage U remains zero from the switching time t3 (on curve B2). In comparison with the related art, in which the voltage curve takes the profile B1, in the present invention the voltage is set to zero at the switching time t3. As a result, the extinguishing phase present in the related art can be prematurely ended, and the voltage U=0 can be applied to the coil of the magnetic actuator. As a result, one end stage of the magnetic actuator can be operated in a so-called “freewheel” mode. As can be seen from the third diagram of FIG. 1, which shows the magnetic force F over time t, at the switching time t3, at which the voltage U is set to zero, a magnetic force decay is significantly slower. This is shown in FIG. 1 by the dashed line C2. The delayed magnetic force decay results in the fact that a resulting force does not increase too rapidly over time. As a result, a slower closing of the gas injector along with less wear and reduced noise arise.

As shown in FIG. 1 in the bottom diagram, the curve D of the valve lift H, which is shown in FIG. 1 in a dashed line and is denoted by D2, also changes. Here, the closing time is shifted from t4 to t4′ by the measure according to the present invention. The closing element then remains closed for the remaining time (curve D2=0).

The present invention is preferably used in gas injectors with two-part closing elements, in which the closing element comprises a valve needle for sealing at the sealing seat and an armature bolt, wherein the armature is fastened to the armature bolt. In the case of such two-part closing elements, two types of closing bounces often occur during the closing process in the related art, namely needle bounces of the valve needle at the sealing seat and armature bounces of the armature at an armature stop. In a needle bounce, only the valve needle collides with the sealing seat while the armature bolt is decoupled and continues to move. Therefore, the bounce height of the valve needle itself is rather low. The armature bounces occur when the armature swings back later, which can force the valve needle open again, which can then lead to unwanted re-injections.

As can further be seen from FIG. 1, the switching time t3 of the voltage to zero occurs after the switching time t2, at which the closing element starts to move from the open position toward the closed position. This switching time is denoted as starting time L in FIG. 1. The starting time L at the switching time t2 occurs after the switching time t1, at which the current I is equal to zero.

The starting time L of the armature is preferably determined on the basis of the current I and the voltage U of the armature.

By switching the voltage U to zero at the switching time t3, a small abrupt increase in the current I also arises, which is represented in FIG. 1 by the curve A2 in a dashed line. This is particularly due to the armature still moving at the switching time t3.

Preferably, the period of time Z up to the switching time t3 is not constant, but depends on the closing behavior of the gas injector. To achieve the best possible braking effect for decelerating the armature, the switching time t3 should be determined very precisely. In the first exemplary embodiment, the switching time t3 is shortly after the starting time L (time t2). Preferably, the switching time t3 is always determined according to the starting time L.

Thus, the concept according to the present invention can prevent the occurrence of closing bounces and, accordingly, inaccuracies in metered quantities and unwanted noises.

FIG. 2 shows a method according to a second exemplary embodiment of the present invention. The second exemplary embodiment substantially corresponds to the first exemplary embodiment, wherein, in contrast to the first exemplary embodiment, the switching time t3 for switching the voltage to zero is selected differently. For simplicity, only the current I and the voltage are shown one above the other in the diagram in FIG. 2. The switching time t3 occurs at a switching time before the current I is equal to zero. As can be seen from FIG. 2, the current I still has the value I1 at the switching time t3. As a result, an earlier deceleration of the armature can be made possible. The period of time Z can be determined for each injection cycle, or an averaged value from a plurality of cycles can be used, for example.

FIG. 3 shows a diagram of a method according to a third exemplary embodiment of the present invention. In FIG. 3, only three diagrams are shown for the current I, the voltage U and the valve lift H over time t.

In the third exemplary embodiment, the variable switching time t3, at which the voltage U is set to zero, is combined with a braking current G. As a result, a braking effect for the armature can be further optimized. Due to the braking effect, which is achieved by switching the voltage to zero at the switching time t3, the armature moves more slowly if a braking current G is applied to the magnetic actuator after the switching time t3. This is the case in FIG. 3 at the switching time t5. Thus, a significantly lower closing speed exists at the switching time for enabling the braking current. However, as a result, greater flexibility in the subsequent braking current application arises. In particular, the requirements for the exact switching time for the braking current can be relaxed or an application window for the braking current can be significantly enlarged. As a result, a significantly more robust method is achieved when using the braking current. Even in the event of incorrect application of the braking current, as a result, less impact on the injector function and, in particular, on possible closing bounces or incorrect injection quantities arises.

As shown in FIG. 3 in the lower diagram of the valve lift H over time t, due to the braking current G, a further shift of the actual closing time t0 the switching time t4′ significantly backwards in time arises. This is shown in FIG. 3 by the sharply flattening dashed line D2.

For all described exemplary embodiments, it should be noted that these methods according to the present invention can also be carried out as learning systems that can be applied to a current switching time t3 on the basis of the switching time t3 determined in the past.

1-12. (canceled)

13. A method for operating a gas injector of an internal combustion engine to avoid closing bounces during a closing process of an armature of a magnetic actuator, the method comprising the following steps:
ending energization of the magnetic actuator at a switching time t0 to initiate the closing process of the gas injector; and
determining a switching time t3, after a period of time Z has elapsed after the switching time t0, at which a voltage U of the magnetic actuator is set to zero.

14. The method according to claim 13, wherein after the energization of the magnetic actuator has ended, a starting time L is determined at a switching time t2 of the armature, and the switching time t3 at which the voltage U is set to zero is determined as a time only after the starting time L.

15. The method according to claim 13, wherein the switching time t3 at which the voltage U is set to zero always occurs after a switching time t1, at which a current I of the magnetic actuator has reached a value of zero during the closing process.

16. The method according to claim 13, wherein the switching time t3 at which the voltage U is set to zero always occurs before the switching time t1, at which a current I of the magnetic actuator has reached the value zero.

17. The method according to claim 13, wherein the switching time t3 is determined according to the starting time L of the armature and/or a closing speed of the armature and/or an actual closing time t4 at which a closing element of the gas injector rests against a sealing seat.

18. The method according to claim 17, wherein the starting time L is determined based on a current I of the magnetic armature and the voltage U of the magnetic actuator.

19. The method according to claim 17, wherein the closing time t4 of the closing element of the gas injector is determined based on a local maximum of a current I of the magnetic armature.

20. The method according to claim 13, wherein after the switching time t3, at which the voltage U is set to zero, a braking current G is applied to reduce a closing speed of the armature.

21. The method according to claim 20, wherein a duration of the braking current G is determined according to the closing speed of the armature.

22. A control unit configured to operate a gas injector of an internal combustion engine to avoid closing bounces during a closing process of an armature of a magnetic actuator, the control unit configured to:
end energization of the magnetic actuator at a switching time t0 to initiate the closing process of the gas injector; and
determine a switching time t3, after a period of time Z has elapsed after the switching time t0, at which a voltage U of the magnetic actuator is set to zero.

23. A non-transitory machine-readable storage medium on which is stored a computer program having program code for operating a gas injector of an internal combustion engine to avoid closing bounces during a closing process of an armature of a magnetic actuator, the program code, when executed by a computer, causing the computer to perform the following steps:
ending energization of the magnetic actuator at a switching time t0 to initiate the closing process of the gas injector; and
determining a switching time t3, after a period of time Z has elapsed after the switching time t0, at which a voltage U of the magnetic actuator is set to zero.
